(19) United States
(12) Patent Application Publication
(10) Pub. No.: US 2015/0098401 A1
(43) Pub. Date: Apr. 9, 2015

(54) METHOD FOR ALLOCATING RESOURCE FOR HYBRID ARQ INFORMATION

(71) Applicant: Pantech Co., Ltd., Seoul (KR)

(72) Inventors: Dong Hyun Park, Seoul (KR); Sung Jun Yoon, Seoul (KR)

(21) Appl. No.: 14/386,563

(22) PCT Filed: Mar. 4, 2013
(86) PCT No.: PCT/KR2013/001711

§ 371 Date: Sep. 19, 2014

(30) Foreign Application Priority Data
Mar. 19, 2012 (KR) 10-2012-0027792

(51) Int. Cl. H04L 1/18; H04W 72/04

(52) U.S. Cl. CPC H04L 1/1861; H04W 72/042
USPC 370/329

(57) ABSTRACT

Provided is a method for allocating a resource for hybrid ARQ information, which is transmitted to a downlink, in a wireless communication system. The method for a transmission point transmitting the hybrid automatic repeat request (ARQ), includes: transmitting to a terminal an index of a group to which each of the terminals belong, along with information on a physical resource block to which an uplink data channel is allocated, and downlink control information for delivering circulation delay information of a reference signal, which is for demodulating an uplink; and transmitting the hybrid ARQ information, which includes whether the uplink data channel that has been transmitted is received, through a resource which is determined on the basis of the information on the physical resource block to which the uplink data channel is allocated, the circulation delay information of the reference signal, and the index of the group.

### CROSS-REFERENCE TO RELATED APPLICATIONS

This application is the National Stage of International Application No. PCT/KR2013/001711, filed on Mar. 4, 2013, and claims priority from and the benefit of Korean Patent Application No. 10-2012-0027792, filed on Mar. 19, 2012, each of which is hereby incorporated by reference for all purposes as if fully set forth herein.

### BACKGROUND

1. Field

The present invention relates to a method of allocating a resource for hybrid Automatic Repeat reQuest (ARQ) information transmitted in a downlink in a wireless communication system.

2. Discussion of the Background

When a packet is transmitted and received in a mobile communication system, a receiver needs to report, to a transmitter, whether or not the reception of a packet is successful. When the reception of a packet is successful, the receiver transmits an acknowledgement (ACK) so as to indicate that the transmitter is to transmit a new packet, and when the receiver fails to receive a packet, the receiver transmits a Negative Acknowledgement (NACK) so as to indicate that the transmitter is to retransmit the packet. This operation is referred to as an Automatic Repeat reQuest (ARQ). A Hybrid ARQ (HARQ) has been provided by coupling the ARQ operation and a channel coding scheme. Information associated with the HARQ may be transferred through a Physical HARQ Indication CHannel (PHICH) set in a control area.

As new communication schemes have developed, there have been occasional cases where a control area is not set or resources of a control area are insufficient. For these cases, resources for transmitting control information may be set in a data area through which data is transmitted, and the control information may be transmitted based on the set resources. It is also possible that information associated with the HARQ is transmitted through a control information transmission resource set in the data area.

In this instance, the resource used for identifying the HARQ information for each User Equipment (UE) may be insufficient. For example, the HARQ information for each UE may be identified by an index of a group and a sequence index in a group, and an identical group index and sequence index may be allocated occasionally with respect to a plurality of UEs. To avoid a conflict, fewer electromagnetic wave resources may be used than actually available electromagnetic wave resources.

### SUMMARY

Therefore, the present invention has been made in view of the above-mentioned problems, and an aspect of the present invention is to provide a method of allocating a resource for a hybrid Automatic Repeat ReQuest (ARQ) indication channel transmitted in a downlink in a wireless communication system.

In accordance with an aspect of the present invention, there is provided a method for a Transmission Point (TP) to transmit hybrid Automatic Repeat reQuest (ARQ) information, the method including: transmitting, to each UE (UE), an index of a group of a corresponding UE, together with downlink control information that transfers information associated with a physical resource block to which an uplink data channel is allocated and Cyclic Shift (CS) information of a reference signal for uplink demodulation; and transmitting hybrid ARQ information including information indicating whether the uplink data channel transmitted from the UE is received, through a resource determined based on the information associated with the physical resource block to which the uplink data channel is allocated, the CS information of the reference signal, and the index of the group.

In accordance with another aspect of the present invention, there is provided a method for a Transmission Point (TP) to transmit hybrid Automatic Repeat reQuest (ARQ) information, the method including: transmitting downlink control information that transfers information associated with a physical resource block to which an uplink data channel is allocated and a Cyclic Shift (CS) information of a reference signal for uplink demodulation; and transmitting hybrid ARQ information including information indicating whether the uplink data channel transmitted from the UE is received, through a resource determined based on the information associated with the physical resource block to which the uplink data channel is allocated, the CS information of the reference signal, and a resource index to which the downlink is control information is allocated.

In accordance with another aspect of the present invention, there is provided a method for a user equipment (UE) to receive hybrid Automatic Repeat reQuest (ARQ) information, the method including: receiving an index of a group to which each UE is included, together with downlink control information that transfers the information associated with a physical resource block to which an uplink data channel is allocated and Cyclic Shift (CS) information of a reference signal for uplink demodulation; transmitting an uplink data channel; and receiving hybrid ARQ information including information indicating whether a Transmission Point (TP) receives the uplink data channel, through a resource determined based on the information associated with the physical resource block to which the uplink data channel is allocated, the CS information of the reference signal, and the index of the group.

In accordance with another aspect of the present invention, there is provided a method for a Transmission Point (TP) to receive hybrid Automatic Repeat reQuest (ARQ) information, the method including: receiving downlink control information that transfers information associated with a physical resource block to which an uplink data channel is allocated and Cyclic Shift (CS) information of a reference signal for uplink demodulation; transmitting an uplink data channel; and receiving hybrid ARQ information including information indicating whether a TP receives the uplink data channel, through a resource determined on the information associated with the physical resource block to which the uplink data channel is allocated, the CS information of the reference signal, and a resource index to which the downlink control information is allocated.

According to the present invention, a resource is allocated for a hybrid Automatic Repeat ReQuest (ARQ) indication channel transmitted in a downlink in a wireless is communication system.

### BRIEF DESCRIPTION OF THE DRAWINGS

FIG. 1 illustrates a wireless communication system according to embodiments of the present invention;

FIG. 2 is a diagram illustrating a PHICH processing process in a Transmission Point (TP);

FIG. 3 illustrates a case in which a single broadband base station and one or more RRHs communicate cooperatively, and the broadband base station and the one or more RRHs use an identical cell ID;

FIG. 4 illustrates a case of allocating an E-PHICH group resource using a plurality of divisions;

FIG. 5 is a flowchart illustrating a method of transmitting an E-PHICH according to an embodiment of the present invention; and

FIG. 6 is a flowchart illustrating a method of transmitting an E-PHICH according to another embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

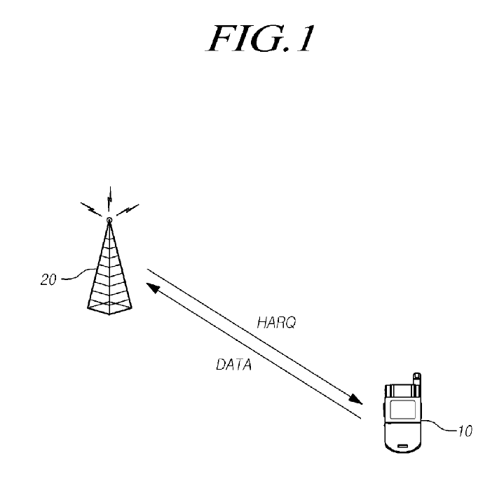

FIG. 1 illustrates a wireless communication system according to embodiments of the present invention.

The wireless communication system may be widely installed so as to provide various communication services, such as a voice service, packet data, and the like.

Referring to FIG. 1, the wireless communication system may include a User Equipment (UE) 10 and a Transmission Point (TP) 20 that executes uplink and downlink communication with the UE 10.

The UE 10 may transmit, to the TP 20, uplink data through a Physical Uplink Shared Channel (PUSCH), and the TP 20 may transmit an HARQ response with respect to the uplink data transmission of the UE 10 through a Physical HARQ Indicator Channel (PHICH).

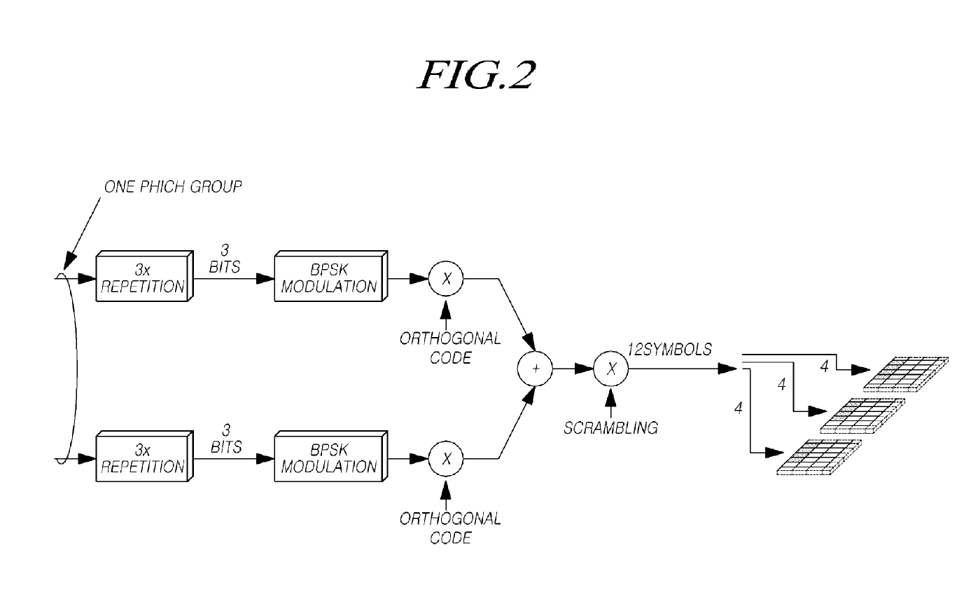

FIG. 2 is a diagram illustrating a PHICH processing process in the TP 20.

Referring to FIG. 2, 1 bit information of HARQ A/N is repeated (repetition) three times, is BiPhase Shift Keying (BPSK) modulated based on an I axis or Q axis, and is spread as an orthogonal sequence having a length of 4 or 2. PHICHs transmitted in an identical set (3 Resource Element Groups (REGs)) of Resource Elements (REs) are referred to as a PHICH group. As shown in Table 1, in a case of a normal Cyclic Prefix (CP), an orthogonal sequence having a length of 4 is used and 8 PHICH sequences form a single PHICH group. In a case of an extended CP, an orthogonal sequence having a length of 2 is used and 4 PHICH sequences form a single PHICH group.

TABLE 1

Orthogonal sequence

| Sequence | Normal cyclic | Extended cyclic |
|---|---|---|
| index | prefix | prefix |
| n_{PHICH}^{seq} | N_{SF}^{PHICH} = 4 | N_{SF}^{PHICH} = 2 |
| 0 | [+1 +1 +1 +1] | [+1 +1] |
| 1 | [+1 −1 +1 −1] | [+1 −1] |
| 2 | [+1 +1 −1 −1] | [+j +j] |
| 3 | [+1 −1 −1 +1] | [+j −j] |
| 4 | [+j +j +j +j] | — |
| 5 | [+j −j +j −j] | — |
| 6 | [+j +j −j −j] | — |
| 7 | [+j −j −j +j] | — |

PHICHs are configured to be in a complex form in a single PHICH group, and the signal is scrambled and then scrambled symbols are mapped to three REGs. Each REG is formed of 4 available REs. Alternatively, each REG may be configured to include a Reference Signal (RS).

A PHICH resource allocated to each UE 10 may be identified by a PHICH group number n_{PHICH}^{group} and an orthogonal sequence index n_{PHICH}^{seq}. The PHICH group number n_{PHICH}^{group} indicates a PHICH group that a PHICH for the UE 10 is included, and the orthogonal sequence index n_{PHICH}^{seq} indicates an index of the PHICH for the UE 10 in the PHICH group. The PHICH group number n_{PHICH}^{group} and the orthogonal sequence index n_{PHICH}^{seq} may be defined by the following Equation 1.

n_{PHICH}^{group}=(I_{PRB}_{_{—}}_{RA}+n_{DMRS})mod N_{PHICH}^{group}+I_{PHICH}N_{PHICH}^{group}

n_{PHICH}^{seq}=(└I_{PRB}_{_{—}}_{RA}/N_{PHICH}^{group}┘+n_{DMRS})mod 2N_{SF}^{PHICH} [Equation 1]

In Equation 1, I_{PRB}_{_{—}}_{RA} denotes an index of the lowest Physical Resource Block (PRB) for transmission of a PUSCH corresponding to a PHICH, n_{DMRS} denotes a Cyclic Shift (CS) value for Demodulation Reference Signal (DM-RS), N_{PHICH}^{group} denotes the number of PHICH groups, I_{PHICH} denotes a value of 1 in the case of PUSCH transmission in subframe n=4 or n=9 in Time Division Duplex (TDD) UL/EL configuration 0 and denotes a value of 0 for the rest, and N_{SF}^{PHICH} denotes a spreading factor used for PHICH modulation, and has a value of 4 in the case of the normal CP and has a value of 2 in the case of the extended CP.

N_{PHICH}^{group} of Equation 1 may be calculated by the following Equation 2.

$${N}_{PHICH}^{group} = \{ \begin{matrix}⌈ {N}_{g} ( {N}_{RB}^{DL} / 8 ) ⌉ & for normal cyclic prefix \\ 2 \cdot ⌈ {N}_{g} ( {N}_{RB}^{DL} / 8 ) ⌉ & for extended cyclic prefix\end{matrix} \qquad [ Equation 2 ]$$

In Equation 2, N_{G}ε{⅙, ½, 1, 2}, transmission may be executed from a TP to a UE through a higher layer signaling such as an RRC, and N_{RB}^{DL} denotes the number of downlink Resource Blocks (RBs).

Electromagnetic wave resources may be classified into a control area and a data area. The control area includes a control channel, such as a Physical Control Format Indicator Channel (PCFICH), a PHICH, a Physical Downlink Control Channel (PDCCH), and the like, and the data area includes a data channel, such as a Physical Downlink Shared Channel (PDSCH) and the like. Meanwhile, in addition to a PHICH allocated to the control area, a new channel for transmission of an HARQ A/N may be required, for the reasons below.

(1) A carrier that does not have a control area, or a carrier that does not have a Cell-specific Reference Signal (CRS) may be considered for a downlink. In this instance, a new is channel for transmission of a PUSCH HARQ ACK/NACK may be required.

(2) Decoding a PUSCH HARQ ACK/NACK may be required using a reference signal which is different from a CRS, to improve a transmission environment using beamforming, Spatial Multiplexing (SM), and frequency domain Inter Cell Interference Coordination (ICIC).

(3) When a plurality of TPs (for example, a single broadband base station and one or more Radio Resource Heads (RRHs)) have an identical cell ID and cooperate for communication, as shown in Coordinated Multi-Point (CoMP) scenario 4, the limited PHICH resources may act as bottleneck when the plurality of TPs cooperate for communication and may limit the cooperative communication.

(4) In a case of uplink Semi-Persistent Scheduling (SPS), the probability of a PHICH resource conflict may increase. To avoid the above, additional UL grant scheduling may be limited.

Due to the above described reasons, a resource for transmitting control information may be allocated to a data area, as opposed to a control area, and a channel for HARQ transmission with respect to uplink transmission corresponding to a PHICH and/or a channel for transmission of downlink control information corresponding to a PDCCH may be set in the resource.

In the present specification, a channel allocated to the data area for transmitting the control information is referred to as an Enhanced Control Channel or an Extended Control Channel (E-CCH), a channel corresponding to a PHICH in the E-CCH is referred to as an is Enhanced PHICH or an Extended PHICH (E-PHICH), and a channel corresponding to a PDCCH is referred to as an Enhanced PDCCH or an Extended PDCCH (E-PDCCH). Alternatively, downlink control information corresponding to a PDCCH is mainly transmitted and thus, a channel allocated to the data area for transmitting the control information may be also referred to as an E-PDCCH. The above described names are for ease of description, and the present invention is not limited to the described names.

The E-PHICH and the E-PDCCH are decoded using a DM-RS.

The resources for the E-PHICH (an E-PHICH group number n_{E-PHICH}^{group} and an E-PHICH sequence index n_{E-PHICH}^{seq} may be expressed by Equation 3 and Equation 4, similar to Equation 1 and Equation 2, which have been described in association with a PHICH.

$$\begin{matrix}{n}_{E - PHICH}^{group} = ( {I}_{PRB \_ RA} + {n}_{DMRS} ) mod {N}_{E - PHICH}^{group} + {I}_{PHICH} {N}_{E - PHICH}^{group} \\ {n}_{E - PHICH}^{seq} = ( ⌊ {I}_{PRB \_ RA} / {N}_{E - PHICH}^{group} ⌋ + {n}_{DMRS} ) mod 2 {N}_{SF}^{E - PHICH} & [ Equation 3 ] \\ {N}_{E - PHICH}^{group} = \{ \begin{matrix}⌈ {N}_{g} ( {N}_{E - CCH}^{DL} / 8 ) ⌉ & for normal cyclic prefix \\ 2 \cdot ⌈ {N}_{g} ( {N}_{E - CCH}^{DL} / 8 ) ⌉ & for extended cyclic prefix\end{matrix} & [ Equation 4 ]\end{matrix}$$

In Equations 3 and 4, N_{E-PHICH}^{group} denotes the number of E-PHICH groups in an E-CCH, and N_{E-CCH}^{DL} denotes the number of downlink RBs (or RB pairs) to which an E-CCH is allocated. N_{E-PHICH}^{group} may be expressed based on another expression of a resource to which an E-PHICH may be allocated.

Meanwhile, in a case in which a plurality of TPs cooperates for communication, when a PHICH resource is allocated based on Equation 1, a conflict may occur.

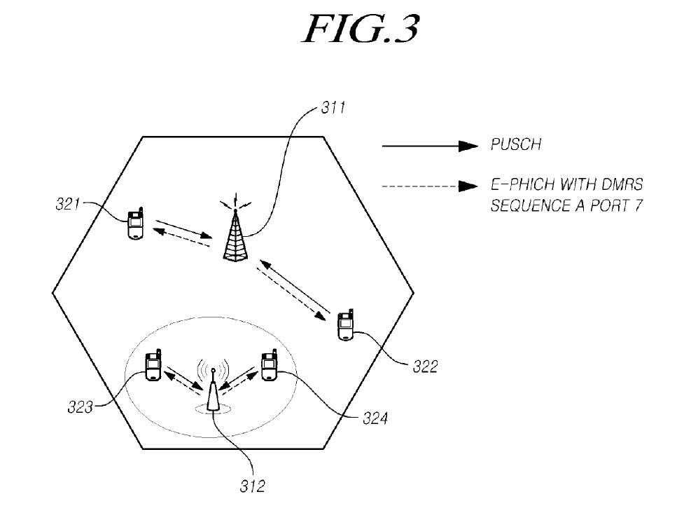

FIG. 3 illustrates a case in which a single broadband base station 311 and one or more RRHs 312 cooperate for communication, and the broadband base station 311 and the one or more RRHs 312 use an identical cell ID. Each of a plurality of UEs 321 through 324 may communicate with a single TP (the broadband base station 311 or the RRH 312), or may communicate with a plurality of TPs (the broadband base station 311 and the RRH 312, or a plurality of RRHs or the like). In FIG. 3, the UE1 321 and the UE2 322 transmit uplink data to the broadband base station 311 through a PUSCH, and the UE3 323 and the UE4 324 transmit uplink data to the RRH 312 through a PUSCH. The broadband base station 311 and the RRH 312 transmit, to the UEs 321 through 324, an HARQ A/N corresponding to the PUSCH that each UE transmits, through an E-PHICH.

The plurality of UEs 321 through 324 may receive the E-PHICH based on a DM-RS resource that is shared by the plurality of UEs. A DM-RS port and a sequence may be semi-statically set for reception of an E-PHICH, for a plurality of UEs or for a specific UE.

In FIG. 3, all of the TPs 311 and 312 may be set to use an identical DM-RS port (for example, a DM-RS port 7) through a Radio Resource Control (RRC) or a method set in advance, or the TPs 311 and 312 may be set to use different DM-RS sequences from one another through an RRC or a method set in advance. In FIG. 3, the broadband base station 311 and the is RRH 312 may be set to use an identical DM-RS sequence A in a port 7. Therefore, all of the UEs 321 through 324 that are connected to the broadband base station 311 and the RRH 312 may be set for receiving a shared E-PHICH.

To effectively use an electromagnetic wave resource, it is considered that UEs that communicate with different TPs execute communication using identical time-frequency resources. In FIG. 3, it is assumed that the UE1 321 that communicates with the broadband base station 311 and the UE3 323 that communicates with the RRH 312 execute PUSCH transmission through an identical RB, using uplink DM-RSs having different Base Sequence Indices (BSIs). In this instance, a cell splitting gain may be obtained. However, when the UE1 321 and the UE3 323 even have an identical CS value of the DM-RS, an E-PHICH group number n_{E-PHICH}^{group} and an orthogonal sequence index n_{E-PHICH}^{seq} for the UE1 321 and the UE3 323 may be identical, with reference to Equation 3. In this instance, a resource conflict does not occur for the PUSCH transmission but an E-PHICH resource for the UE1 321 conflicts with an E-PHICH resource for the UE3 323.

The above problem may become worse when a plurality of uplink SPS UEs exist. As a condition for triggering uplink SPS transmission, a CS of a DM-RS may be set to ‘000’. When a plurality of SPS UEs use an identical RB, E-PHICH resources thereof may conflict.

To avoid an E-PHICH resource conflict, at least one of the lowest PRB index of a PUSCH transmitted by the plurality of UEs and a CS of a DM-RS needs to be different from one another. In particular, in the case of an SPS UE of which a CS value of a DM-RS is determined, an RB through which a PUSCH is transmitted may be limited to not be identical to one another. This may cause a great limit of a whole system performance in a wireless communication system.

For example, a total number of E-PHICH groups may be increased and an E-PHICH resource for UEs included in a group of UEs that communicate with a predetermined TP or UEs included in a group set based on another criterion may be set to be different from an E-PHICH resource for UEs included in another group. Hereinafter, although a group of UEs set for E-PHICH resource allocation may be referred to as a division, the present invention may not be limited to the expression. For example, in FIG. 3, it is set that UEs that communicate with the broadband base station 311 are included in a division 0 (or UE group 0) and UEs that communicate with the RRH 312 are included in a division 1 (or UE group 1).

The number of E-PHICH groups N_{E-PHICH}^{group} included in a single division may be expressed as shown in Equation 4. When the number of divisions is K, in a case of FDD, the total number of E-PHICH groups is N_{E-PHICH}^{group}×K, and in the case of TDD, the total number of E-PHICH groups is N_{E-PHICH}^{group}×K×mᵢ. A value of mi may be 2 only in downlink subframes #0 and #6 of TDD UL-DL configuration 0, and may be 1 for the rest.

In this instance, the total number of E-PHICH groups may be adjusted using K (that is, the number of divisions). K may be transmitted on a higher layer using an RRC, or may be transmitted through a dynamic method (for example, an implicit method using a field in a PDCCH or an explicit method using an additional field in a PDCCH). K may be 2 but the value may vary based on a communication environment. Hereinafter, a case in which K is 2 will be exemplified.

As described above, when the total number of E-PHICH groups increases, the E-PHICH group number n_{E-PHICH}^{group} and the E-PHICH sequence index n_{E-PHICH}^{seq} may be expressed as shown in the following Equation 5.

$${n}_{E - PHICH}^{group} = ( {I}_{PRB \_ RA} + {n}_{DMRS} ) mod {N}_{E - PHICH}^{group} + ( {I}_{UE \_ groupID} + K \times {I}_{PHICH} ) \times {N}_{E - PHICH}^{group} \\ {I}_{UE \_ groupID} = \{ \begin{matrix}0 & UE group 0 \\ 1 & UE group 1 \\ … & \\ k & UE group k \\ … & \\ K - 1 & UE group K - 1\end{matrix} \} \\ {n}_{E - PHICH}^{seq} = ( ⌊ {I}_{PRB \_ RA} / {N}_{E - PHICH}^{group} ⌋ + {n}_{DMRS} ) mod 2 {N}_{SF}^{PHICH} \qquad [ Equation 5 ]$$

In Equation 5, I_{UE}_{_{—}}_{groupID} denotes an identifier of a division (or a UE group or a Transmission Point (TP)). When the number of divisions is K, I_{UE}_{_{—}}_{grownID} may have a value of 0 through K−1. Alternatively, I_{UE}_{_{—}}_{groupID} may be set to be Iₜₚ_{_{—}}_{ID} and thus, may have an identical value to one another or have different values for each TP. For example, in a system including a broadband base station, an RRH1, and an RRH2, K=2, Iₜₚ_{_{—}}_{ID} of the broadband base station is set to 0, and Iₜₚ_{_{—}}_{ID} of the RRH1 and the RRH2 may be set to 1.

In comparison with Equation 3, Equation 5 weightedly considers I_{UE}_{_{—}}_{groupID}, which is an index of a UE group, when the E-PHICH group number n_{E-PHICH}^{group} is calculated, and an E-PHICH sequence index n_{E-PHICH}^{seq} is identical. When the index I_{UE}_{_{—}}_{groupID} of the UE group is 0, Equation 5 is identical to Equation 3.

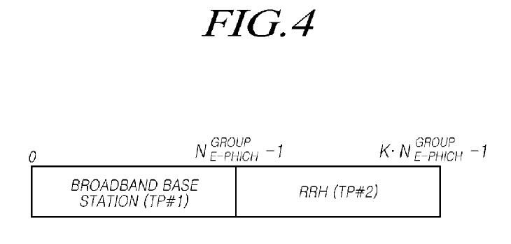

For example, a UE group identifier I_{UE}_{_{—}}_{groupID} of a UE that communicates with the broadband base station 311 is set to 0 and a UE group identifier I_{UE}_{_{—}}_{groupID} of a UE that communicates with the RRH 312 may be set to a value greater than 0. According to Equation 5, as shown in FIG. 4, a value of I_{PHICH} of a UE that communicates with the broadband base station 311 TP#1 is set to 0 and thus, the E-PHICH group number n_{E-PHICH}^{group} has a value of 0 through N_{E-PHICH}^{group}−1, and a value of I_{PHICH} of a UE that communicates with an RRH 312 TP#2 is set to a value greater than 0 and thus, the E-PHICH group number n_{E-PHICH}^{group} may have a value of N_{E-PHICH}^{group} through K·N_{E-PHICH}^{group}−1.

Therefore, although the lowest PRB indices for PUSCH transmission and DM-RS CS values of the UE that communicate with the broadband base station 311 and the UE that group communicates with the RRH 312 are identical, the E-PHICH group numbers n_{E-PHICH}^{group} thereof may be determined to be different from each other. A difference between the E-PHICH group numbers n_{E-PHICH}^{group} for two UEs having the identical lowest PRB index for PUSCH transmission and the identical DM-RS CS value may be an integer multiple of the number of E-PHICH groups N_{E-PHICH}^{group}.

Although the described example illustrates that the UE group is classified by being specified to a TP, the present invention may not be limited thereto, and the UEs may be classified into groups based on another criterion. In this instance, each of the UEs belonging to different groups may have the lowest PRB index for PUSCH transmission and a DM-RS CS is value.

The UE group identifier I_{UE}_{_{—}}_{groupID} may be signaled from a TP to a UE by being specified to the TP or specified to the UE.

For example, the UE group identifier I_{UE}_{_{—}}_{groupID} may be implicitly transferred. The UE group identifier I_{UE}_{_{—}}_{groupID} may be determined based on an index of a Control Channel Element (CCE) forming a PDCCH (or E-PDCCH) that indicates corresponding PUSCH transmission, an RB index, or an REG index (for example, an index of a first CCE, an index of a first RB, or an index of a first REG). For example, the UE group identifier I_{UE}_{_{—}}_{groupID} may be a remainder obtained after dividing the index of the first CCE, the index of the first RB, or the index of the first REG by the number of the UE groups (divisions). For example, when the UE group identifier I_{UE}_{_{—}}_{groupID} is determined based on the index of the first CCE forming the PDCCH (or E-PDCCH), the UE group identifier I_{UE}_{_{—}}_{groupID} may be determined by the following Equation 6.

I_{UE}_{_{—}}_{groupID}n_{CCE} mod K [Equation 6]

When the UE group identifier I_{UE}_{_{—}}_{groupID} is signaled in this manner, the UE group identifier I_{UE}_{_{—}}_{groupID} may be transferred dynamically from a TP to a UE without a signaling overhead.

Alternatively, the UE group identifier I_{UE}_{_{—}}_{groupID} may be implicitly transferred using a field value included in an uplink grant (UL grant) of a PDCCH set for activation of an Uplink SPS.

The following Table 2 indicates a field of Downlink Control Information (DCI) format 0 for validation of an uplink SPS activation PDCCH.

TABLE 2

| | DCI format 0 |
|---|---|
| TPC command for | set to ‘00’ |
| scheduled PUSCH | |
| Cyclic shift DM RS | set to ‘000’ |
| Modulation and | MSB is set to ‘0’ |
| coding scheme and | |
| redundancy version | |

Referring to Table 2, in a case of a UE of which a DM-RS CS value is set to ‘000’ and an uplink SPS is activated, I_{UE}_{_{—}}_{groupID}=0. In a case of a UE of which a DM-RS CS value is set to ‘111’ or an MSB value is set to ‘1’, I_{UE}_{_{—}}_{groupID}=1.

When the UE group identifier I_{UE}_{_{—}}_{groupID} is signaled in this manner, the UE group identifier I_{UE}_{_{—}}_{groupID} may be transferred dynamically from a TP to a UE without a separate signaling overhead.

As another example, the UE group identifier I_{UE}_{_{—}}_{groupID} may be explicitly transferred. An additional field may be allocated to a PDCCH (or E-PDCCH) that indicates PUSCH transmission, that is, a DCI format, so as to indicate the UE group identifier I_{UE}_{_{—}}_{groupID}. The following Table 3 shows a case in which K=2.

TABLE 3

| Bit value | I_{UE}_{_{—}}_{groupID} (when K = 2) |
|---|---|
| 0 | 0 |
| 1 | 1 |

Alternatively, an additional field may be allocated to an RRC signaling so as to indicate the UE group identifier I_{UE}_{_{—}}_{groupID}.

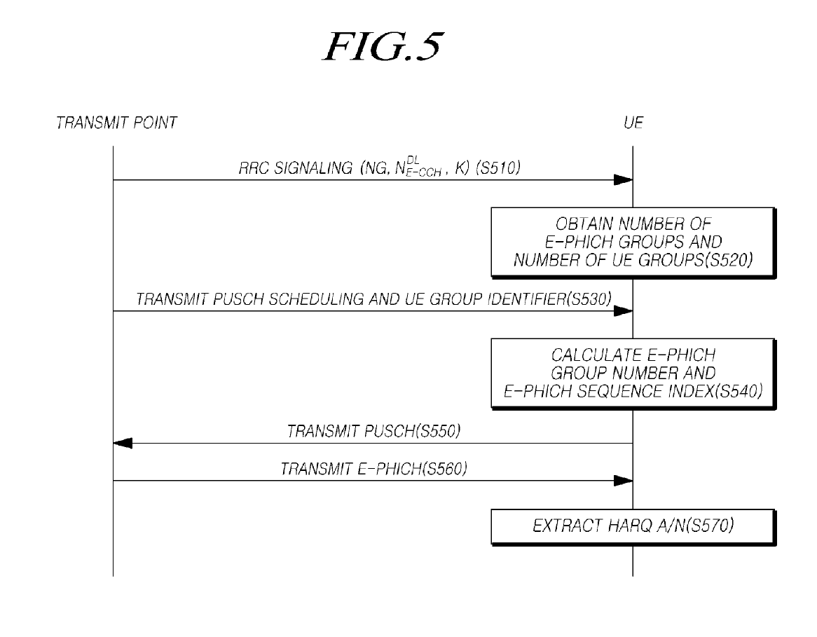

FIG. 5 is a flowchart illustrating a method of transmitting an E-PHICH according to an embodiment of the present invention.

Referring to FIG. 5, a TP transmits N_{G}, N_{E-CCH}^{DL}, and K, as parameters associated with an E-PHICH, to a UE through an RRC signaling, in operation S510. N_{G} may be selected to be one of the ⅙, ½, 1, and 2, and also, may have a value greater than those values (4, 6, . . . ). N_{E-CCH}^{DL} denotes the number of RBs (or RB pairs) to which an E-CCH is allocated, and when the information is recognizable from an RB (or RB pair) to which an E-CCH is set, a signaling may be omitted. K denotes the number of UE groups (divisions).

A UE that receives N_{G}, N_{E-CCH}^{DL}, and K may determine the number of E-PHICH groups N_{E-PHICH}^{group} and the number of UE groups (divisions), in operation S520.

The TP transmits uplink scheduling information and/or a UE group identifier I_{UE}_{_{—}}_{groupID} to the UE through a PDCCH or an E-PDCCH, in operation S530. Alternatively, the TP may transmit the UE group identifier I_{UE}_{_{—}}_{groupID} through an RRC. The uplink scheduling information includes information associated with an RB for PUSCH transmission, from which an index I_{PRB}_{_{—}}_{RA} of the lowest PRB for PUSCH transmission may be extracted. Also, the uplink scheduling information may include cyclic shift information n_{DMRS} for a DM-RS for uplink demodulation.

For example, the UE group identifier I_{UE}_{_{—}}_{groupID} may be implicitly or explicitly transferred. For example, the UE group identifier I_{UE}_{_{—}}_{groupID} may be transferred implicitly through an index of a CCE forming a PDCCH (or E-PDCCH), or an RB index, or an REG index. Alternatively, the UE group identifier I_{UE}_{_{—}}_{groupID} may be transferred implicitly through cyclic shift information for a DM-RS or modulation and coding scheme information. Alternatively, the UE group identifier I_{UE}_{_{—}}_{groupID} may be explicitly transferred through a PDCCH (or E-PDCCH).

The UE applies, to Equation 5, the number of E-PHICH groups N_{E-PHICH}^{group} and the number of UE groups (K) calculated based on information extracted from the RRC signaling, and the index I_{PRB}_{_{—}}_{RA} of the lowest PRB for PUSCH transmission, the cyclic shift information n_{DMRS} for the DM-RS for uplink demodulation, and the UE group identifier I_{UE}_{_{—}}_{groupID}, which are extracted from control information transferred through a PDCCH (or E-PDCCH), so as to calculate an E-PHICH group number n_{E-PHICH}^{group} and an E-PHICH sequence index n_{E-PHICH}^{seq}, in operation S540.

The UE that receives the uplink scheduling information in operation S530 executes PUSCH transmission to the TP in operation S550, and the TP transmits an HARQ A/N is with respect to the PUSCH transmitted by the UE, through an E-PHICH, in operation S560. In this instance, E-PHICH resource allocation is based on Equation 5. The UE extracts the HARQ A/N based on the E-PHICH resource allocation information (the E-PHICH group number n_{E-PHICH}^{group} and the E-PHICH sequence index n_{E-PHICH}^{seq}) calculated in operation S540, in operation S570.

Alternatively, the E-PHICH group number n_{E-PHICH}^{group} and the E-PHICH sequence index n_{E-PHICH}^{seq} are adjusted to be different for each UE, without an increase in the total number of E-PHICH groups. That is, although indices I_{PRB}_{_{—}}_{RA} of the lowest PRB for PUSCH transmission and cyclic shift information n_{DMRS} of UEs are identical, the E-PHICH group number n_{E-PHICH}^{group} and E-PHICH sequence index are adjusted to be different for each UE.

In the present embodiment, the E-PHICH group number n_{E-PHICH}^{group} and the E-PHICH sequence index n_{E-PHICH}^{seq} are defined by the following Equation 7.

n_{E-PHICH}^{group}=(I_{PRB}_{_{—}}_{RA}+n_{DMRS}+n_{CCE})mod N_{E-PHICH}^{group}+I_{PHICH}N_{E-PHICH}^{group}

n_{E-PHICH}^{seq}=(└I_{PRB}_{_{—}}_{RA}/N_{E-PHICH}^{group}┘+n_{DMRS}+n_{CCE})mod 2N_{SF}^{PHICH} [Equation 7]

In Equation 7, the E-PHICH group number n_{E-PHICH}^{group} and the E-PHICH sequence index n_{E-PHICH}^{seq} are calculated based on an index n_{CCE} of a first CCE forming a PDCCH (or E-PDCCH) in addition to the index I_{PRB}_{_{—}}_{RA} of the lowest PRB for PUSCH transmission and the cyclic shift information n_{DMRS} for the DM-RS. Therefore, even when UEs (particularly, SPS UEs) have identical index I_{PRB}_{_{—}}_{RA} of the lowest PRBs for PUSCH transmission and identical cyclic shift information n_{DMRS} for DM-RS, the E-PHICH group number n_{E-PHICH}^{group} and the E-PHICH sequence index n_{E-PHICH}^{seq} are set to be different by adjusting the index n_{CCE} of the first CCE forming the PDCCH (or E-PDCCH) indicating UL SPS activation.

However, the total number of E-PHICH groups does not increase and thus, a probability of an E-PHICH resource conflict does not decrease. However, a conflict may be prevented within the limited E-PHICH resources using a new parameter n_{CCE}.

The present embodiment may consider increasing the number of E-PHICH groups. N_{G}ε{⅙, ½, 1, 2} is satisfied in Equation 4 that calculates the number of E-PHICH groups N_{E-PHICH}^{group} in an E-CCH. The present embodiment increases the number of E-PHICH groups by setting N_{G}ε{⅙, ½, 1, 2, 4, 6 . . . }, which is an increased value, and adjusts I_{PRB}_{_{—}}_{RA}, n_{DMRS}, and n_{CCE} in the increased E-PHICH group resources.

Alternatively, the E-PHICH group number n_{E-PHICH}^{group} and the E-PHICH sequence index n_{E-PHICH}^{seq} may be determined based on the UE group identifier and an index n_{CCE} of the first CCE forming the PDCCH (or E-PDCCH). For example, the E-PHICH group number n_{E-PHICH}^{group} and the E-PHICH sequence index n_{E-PHICH}^{seq} may be calculated by the following Equation 8.

$${n}_{E - PHICH}^{group} = ( {I}_{PRB \_ RA} + {n}_{DMRS} + {n}_{CCE} ) mod {N}_{E - PHICH}^{group} + ( {I}_{UE \_ groupID} + K \times {I}_{PHICH} ) \times {N}_{E - PHICH}^{group} \\ {I}_{UE \_ groupID} = \{ \begin{matrix}0 & UE group 0 \\ 1 & UE group 1 \\ … & \\ k & UE group k \\ … & \\ K - 1 & UE group K - 1\end{matrix} \} \\ {n}_{E - PHICH}^{seq} = ( ⌊ {I}_{PRB \_ RA} / {N}_{E - PHICH}^{group} ⌋ + {n}_{DMRS} + {n}_{CCE} ) mod 2 {N}_{SF}^{PHICH} \qquad [ Equation 8 ]$$

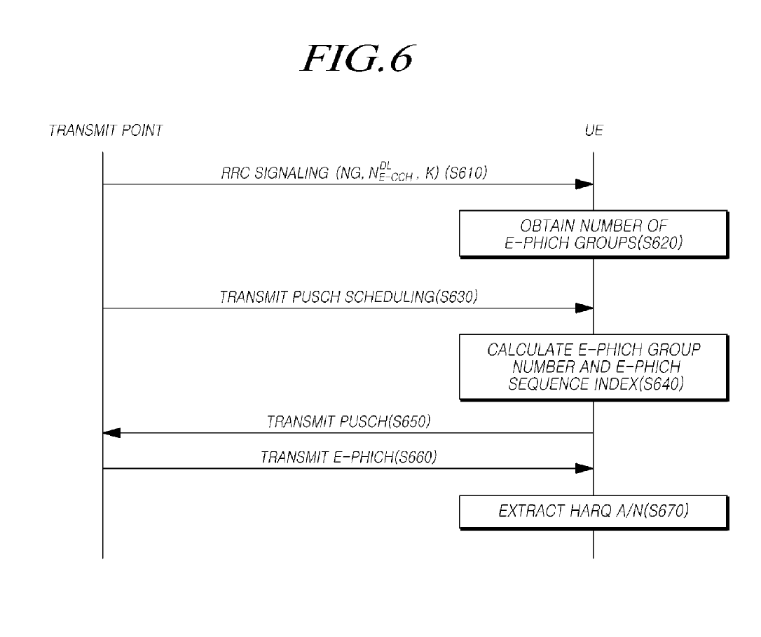

FIG. 6 is a flowchart illustrating a method of transmitting an E-PHICH according to another embodiment of the present invention.

Referring to FIG. 6, a TP transmits N_{G} and N_{E-CCH}^{DL}, as parameters associated with an E-PHICH, to a UE through an RRC signaling, in operation S610. N_{G} may be selected to be one of the ⅙, ½, 1, and 2, and also, may have a value greater than those values (4, 6, . . . ). N_{E-CCH}^{DL} denotes the number of RBs (or RB pairs) to which an E-CCH is allocated, and when the information is recognizable from an RB (or RB pair) to which an E-CCH is set, a signaling may be omitted.

The UE that receives N_{G} and N_{E-CCH}^{DL} determine the number of E-PHICH groups N_{P-PHICH}^{group} using the same, in operation S620.

The TP transmits uplink scheduling information to the UE, through a PDCCH or an E-PDCCH, in operation S630. The uplink scheduling information includes information associated with an RB for PUSCH transmission, from which an index I_{PRB}_{_{—}}_{RA} of the lowest PRB for PUSCH transmission may be extracted. Also, the uplink scheduling information may is include cyclic shift information n_{DMRS} for a DM-RS for uplink demodulation. Also, an index n_{CCE} of a first CCE forming a PDCCH or E-PDCCH through which the uplink scheduling information is transferred, may be extracted.

The UE calculates an E-PHICH group number n_{E-PHICH}^{seq} and an E-PHICH sequence index n_{E-PHICH}^{group} by applying, to Equation 7, the number of E-PHICH groups extracted from an RRC signaling, and the index I_{PRB}_{_{—}}_{RA} of the lowest PRB for PUSCH transmission, the cyclic shift information n_{DMRS} for the DM-RS for uplink demodulation, and the index n_{CCE} of the first CCE forming the PDCCH or E-PDCCH, which are extracted from control information transferred through the PDCCH (or E-PDCCH), in operation S640.

A UE group identifier I_{UE}_{_{—}}_{groupID} is also implicitly or explicitly transferred in group operation S630, and the E-PHICH group number n_{E-PHICH}^{group} and the E-PHICH sequence index n_{E-PHICH}^{seq} may be calculated using Equation 8 in operation S640.

The UE that receives the uplink scheduling information in operation S630 transmits PUSCH transmission to the TP in operation S650, and the TP transmits an HARQ A/N with respect to the PUSCH transmitted by the UE, through an E-PHICH, in operation S660. In this instance, E-PHICH resource allocation is based on Equation 5. The UE extracts the HARQ A/N based on the E-PHICH resource allocation information calculated in operation S640 (the E-PHICH group number n_{E-PHICH}^{group} and the E-PHICH sequence index n_{E-PHICH}^{seq}) in operation S670.

Although the embodiments of the present invention have been described for is illustrative purposes, those skilled in the art will appreciate that various modifications, additions and substitutions are possible, without departing from the scope and spirit of the invention. Accordingly, the embodiments disclosed in the present invention are only for describing, but not limiting, the technical idea of the present invention, and the scope of the technical idea of the present invention is not limited by the embodiments. The scope of the present invention shall be construed on the basis of the accompanying claims in such a manner that all of the technical ideas included within the scope equivalent to the claims belong to the present invention.

1. A method for a Transmission Point (TP) to transmit hybrid Automatic Repeat reQuest (ARQ) information, the method comprising:
transmitting, to each User Equipment (UE), an index of a group of a corresponding UE, together with downlink control information that transfers information associated with a physical resource block to which an uplink data channel is allocated and Cyclic Shift (CS) information of a reference signal for uplink demodulation; and
transmitting hybrid ARQ information including information indicating whether the uplink data channel transmitted from the UE is received, through a resource determined based on the information associated with the physical resource block to which the uplink data channel is allocated, the CS information of the reference signal, and the index of the group.

2. The method as claimed in claim 1, wherein the index of the group is determined based on a resource index to which the downlink control information is allocated.

3. The method as claimed in claim 1, wherein the index of the group is determined based on the CS information of the reference signal or a modulation and encoding scheme.

4. The method as claimed in claim 1, wherein information associated with the index of the group is transferred through the downlink control information.

5. The method as claimed in claim 1, wherein resource information of the hybrid ARQ information is determined based on the following equation:
n_{E-PHICH}^{group}=(I_{PRB}_{_{—}}_{RA}+n_{DMRS})mod N_{PHICH}^{group}+(I_{UE}_{_{—}}_{groupID}+K×I_{PHICH})×N_{E-PHICH}^{group}
n_{PHICH}^{seq}=(└I_{PRB}_{_{—}}_{RA}/N_{E-PHICH}^{group}┘+n_{DMRS})mod 2N_{SF}^{PHICH}
wherein n_{E-PHICH}^{group} and n_{E-PHICH}^{seq} denote a group number and a sequence index of the hybrid ARQ information, respectively, I_{PRB}_{_{—}}_{RA} denotes an index of the lowest resource block for the uplink data channel, n_{DMRS} denotes a CS value for the reference signal, N_{E-PHICH}^{group} denotes the number of hybrid ARQ information groups, I_{UE}_{_{—}}_{groupID} denotes an index of the group, K denotes the number of groups, I_{PHICH} denotes a value of 0 or 1, and N_{SF}^{PHICH} denotes a spreading factor used for modulating hybrid ARQ information.

6. The method as claimed in claim 1, further comprising:
transmitting, to the UE, information associated with the number of groups.

7. A method for a Transmission Point (TP) to transmit hybrid Automatic Repeat reQuest (ARQ) information, the method comprising:
transmitting downlink control information that transfers information associated with a physical resource block to which an uplink data channel is allocated and Cyclic Shift (CS) information of a reference signal for uplink demodulation; and
transmitting hybrid ARQ information including information indicating whether the uplink data channel transmitted from a User Equipment (UE) is received, through a resource determined based on the information associated with the physical resource block to which the uplink data channel is allocated, the CS information of the reference signal, and a resource index to which the downlink control information is allocated.

8. The method as claimed in claim 7, wherein resource information of the hybrid ARQ information is determined based on the following equation:
n_{E-PHICH}^{group}=(I_{PRB}_{_{—}}_{RA}+n_{DMRS}+n_{CCE})mod N_{E-PHICH}^{group}+I_{PHICH}N_{E-PHICH}^{group}
n_{E-PHICH}^{seq}=(└I_{PRB}_{_{—}}_{RA}/N_{E-PHICH}^{group}┘+n_{DMRS}n_{CCE})mod 2N_{SF}^{PHICH}
wherein n_{E-PHICH}^{group} and n_{E-PHICH}^{seq} denote a group number and a sequence index of the hybrid ARQ information, respectively, I_{PRB}_{_{—}}_{RA} denotes an index of the lowest resource block for the uplink data channel, n_{DMRS} denotes a CS value for the reference signal, n_{CCE} denotes an index of a control channel element through which a downlink indication channel is transferred, n_{E-PHICH}^{group} denotes the number of hybrid ARQ indication channel groups, I_{PHICH} denotes a value of 0 or 1, and N_{SF}^{PHICH} denotes a spreading factor used for modulating a hybrid ARQ indication channel.

9. A method for a user equipment (UE) to receive hybrid Automatic Repeat reQuest (ARQ) information, the method comprising:
receiving an index of a group of a corresponding UE, together with downlink control information that transfers information associated with a physical resource block to which an uplink data channel is allocated and Cyclic Shift (CS) information of a reference signal for uplink demodulation;
transmitting the uplink data channel; and
receiving hybrid ARQ information including information indicating whether a Transmission Point (TP) receives the uplink data channel, through a resource determined based on the information associated with the physical resource block to which the uplink data channel is allocated, the CS information of the reference signal, and the index of the group.

10. The method as claimed in claim 9, wherein the index of the group is determined based on a resource index to which the downlink control information is allocated.

11. The method as claimed in claim 9, wherein the index of the group is determined based on CS information of the reference signal or a modulation and encoding scheme.

12. The method as claimed in claim 9, wherein the information associated with the index of the group is transferred through the downlink control information.

13. The method as claimed in claim 9, wherein resource information of the hybrid ARQ information is determined based on the following equation:
n_{E-PHICH}^{group}=(I_{PRB}_{_{—}}_{RA}+n_{DMRS})mod N_{PHICH}^{group}+(I_{UE}_{_{—}}_{groupID}+K+I_{PHICH})×N_{E-PHICH}^{group}
n_{E-PHICH}^{seq}=(└I_{PRB}_{_{—}}_{RA}/N_{E-PHICH}^{group}┘+n_{DMRS})mod 2N_{SF}^{PHICH}
wherein n_{E-PHICH}^{group} and n_{E-PHICH}^{seq} denote a group number and a sequence index of the hybrid ARQ information, respectively, I_{PRB}_{_{—}}_{RA} denotes an index of the lowest resource block for the uplink data channel, n_{DMRS} denotes a CS value for the reference signal, N_{E-PHICH}^{group} denotes the number of hybrid ARQ indication channel groups, I_{UE}_{_{—}}_{groupID} denotes an index of the group, K denotes the number of groups, I_{PHICH} denotes a value of 0 or 1, and N_{SF}^{PHICH} denotes a spreading factor used for modulating a hybrid ARQ indication channel.

14. The method as claimed in claim 9, further comprising:
receiving information associated with the number of groups, before receiving of the group index.

15. A method for a Transmission Point (TP) to receive hybrid Automatic Repeat reQuest (ARQ) information, the method comprising:
receiving downlink control information that transfers information associated with a physical resource block to which an uplink data channel is allocated and Cyclic Shift (CS) information of a reference signal for uplink demodulation;
transmitting the uplink data channel; and
receiving hybrid ARQ information including information indicating whether a TP receives the uplink data channel, through a resource determined on the information associated with the physical resource block to which the uplink data channel is allocated, the CS information of the reference signal, and a resource index to which the downlink control information is allocated.

16. The method as claimed in claim 15, wherein resource information of the hybrid ARQ information is determined based on the following equation:
n_{E-PHICH}^{group}=(I_{PRB}_{_{—}}_{RA}+n_{DMRS}+n_{CCE})mod N_{E-PHICH}^{group}+I_{PHICH}N_{PHICH}^{group}
n_{E-PHICH}^{seq}=(└I_{PRB}_{_{—}}_{RA}/N_{PHICH}^{group}┘+n_{DMRS}+n_{CCE})mod 2N_{SF}^{PHICH}
wherein n_{E-PHICH}^{group} and n_{E-PHICH}^{seq} denote a group number and a sequence index of the hybrid ARQ information, respectively, I_{PRB}_{_{—}}_{RA} denotes an index of the lowest resource block for the uplink data channel, n_{DMRS} denotes a CS value for the reference signal, n_{CCE} denotes an index of a control channel element through which a downlink indication channel is transferred, N_{E-PHICH}^{group} denotes the number of hybrid ARQ indication channel groups, I_{PHICH} denotes a value of 0 or 1, and N_{SF}^{PHICH} denotes a spreading factor used for modulating a hybrid ARQ indication channel.
